(19) United States
(12) Patent Application Publication
(10) Pub. No.: US 2002/0176549 A1
(43) Pub. Date: Nov. 28, 2002

(54) Method for processing voice mail message call returns

(75) Inventor: Hector E. Monsivais de Valle, Saltillo (MX)

Correspondence Address: ANDRE M. SZUWALSKI, Jenkens & Gilchrist, P.C., 1445 Ross Avenue, Dallas, TX, 75202-2799, US

(73) Assignee: Telefonaktiebolaget LM Ericsson (publ)

(21) Appl. No.: 09/864,477

(22) Filed: May 23, 2001

(51) Int. Cl. H04M 11/00; H04M 11/10

(52) U.S. Cl. 379/88.18; 455/412

(57) ABSTRACT

A method for providing call return services from within a voice mail service (VMS) includes the steps of receiving a call for the VMS from a calling number, verifying that a voice mail call return feature is active in conjunction with the calling number, establishing a first connection between another node (such as an associated mobile switching center) and the VMS, accessing the VMS, finding a message having a call return number, establishing a second connection between the node and the VMS, controlling the call using the node, releasing the second connection, and establishing a third connection between the node and the call return number. The method may also include the steps of releasing the first and second connections, either before or after obtaining an answer from the call return number.

### BACKGROUND OF THE INVENTION

1. Technical Field

This invention relates generally to apparatus and methods for recording telephone messages, such as answering machines and voice mail. More particularly, the invention relates to a method that enables voice mail subscribers to return calls from within the voice mail system, while listening to messages.

2. History of Related Art

Several different types of devices and methods exist for recording messages left by a calling party. The most common is a simple answering machine with a tape cassette or digital memory recorder activated after a predetermined number of rings at the called telephone.

A more sophisticated version of the answering machine is implemented within a Voice Mail Service (VMS), which offers the ability to record messages from calling parties which fail to reach the called party in person. Features include pre-recorded greetings, paging, future delivery of messages, call transfer, and call forwarding. The VMS, which may be apart from, or reside within, a network node or telephone switch, is typically activated when the calling party fails to reach the called party, due to the called party failing to answer the phone or when the called party is otherwise occupied in a telephone conversation with a third party.

The VMS allows a calling party to leave a voice message, as well as a telephone number for returning the call. This number may be the number of the calling party, as received in the signaling messages from a node or switch connected to the VMS, which allows the call to be returned from the VMS. However, the prior art requires maintaining two connections between the node or switch and the VMS to enable making the return call.

As can be seen FIG. 1, the prior art method for processing return calls from a VMS begins with requesting voice mail services from the VMS in Step 20. At this point, the first connection is established between the node communicating with the subscriber, and the VMS in step 30. The subscriber access password is (optionally) secured by the VMS in step 40, and the subscriber is allowed to begin listening to messages in step 50.

If the subscriber determines that the voice mail services should be terminated, by hanging up, or otherwise indicating that no more messages are to be heard in step 60, then the first connection is released in step 70, and the method ends. Otherwise, the prior art method determines whether some type of call return activity is desired while the message is played in step 90. If not, then the method continues with playing the messages in the voice mail service queue for the subscriber in step 50. Otherwise, if the subscriber desires to return a call, then the message currently being played is marked by the VMS in step 100, and the second connection from the VMS to the node is established in step 110. At this point, the call connection between the subscriber and the calling party located at the return call number is made in step 120, and a conversation is established in step 130. Until the conversation is terminated in step 140, the conversation continues in step 130.

Upon termination in step 140, the second connection between the node and the VMS is released in step 150, and the method continues with playing voice mail messages in step 50.

The difficulty with the prior art method illustrated in FIG. 1 is that each time a voice mail subscriber orders a call return for a voice mail message left with the VMS, two connections between the node and the VMS are required to provide this service. These connections are in addition to the connection maintained between the subscriber telephone and the node, along with the connection between the called party and the node. The two connections between the node and the VMS are maintained throughout the duration of the call return activity, including the conversation between the subscriber and the called party. This inefficient prior art method limits the call capacity for the telecommunication system service provider, since the node and VMS are each occupied with two connections for every return call.

Therefore, what is needed is a method of processing voice mail message call returns by a node and a VMS which does not require two connections. Or, if two connections are required, then the method should provide for at least one of the connections to be dropped at some point before the conversation between the subscriber and the called party is initiated. Such a method would increase the overall service capability of the telecommunications service provider, by augmenting the physical call servicing ability of the node and the VMS. Further such a method would be most useful if several embodiments were available to provide increased service efficiency according to the particular switching and service timing needs of the telecommunications service provider.

### SUMMARY OF THE INVENTION

The method of present invention for processing voice mail message call returns avoids the requirement for maintaining two connections between the node and the VMS when a subscriber requests a call return while using VMS voice mail. Essentially, three embodiments of the method are available for use by telecommunications service provider. First, during call return activity, only one connection between the node and the VMS is maintained. Second, during call return activity, after the return call is answered by the called party, no connections are maintained between the node and the VMS. Third, during call return activity, and without waiting for an answer by the called party, no connections are maintained between the node and the VMS.

In every case, the node takes control of the call return activity, rather than the VMS. In this manner, either one or both of the connections between the node and the VMS can be released during call return activity. That is, during call return operations, the connection between the subscriber and the calling party is made by the node, and not the VMS. Following termination of the return call, subscribers have the option to return to the voice mail services provided by the VMS. Thus, after termination of the return call, the subscriber is permitted to retrieve and listen to subsequent messages from the VMS.

### BRIEF DESCRIPTION OF THE DRAWINGS

A more complete understanding of the structure and operation of the present invention may be had by reference to the following detailed description when taken in conjunction with the accompanying drawings, wherein:

FIG. 1, previously described, is a signal flow diagram illustrating the prior art method of processing voice mail message call returns;

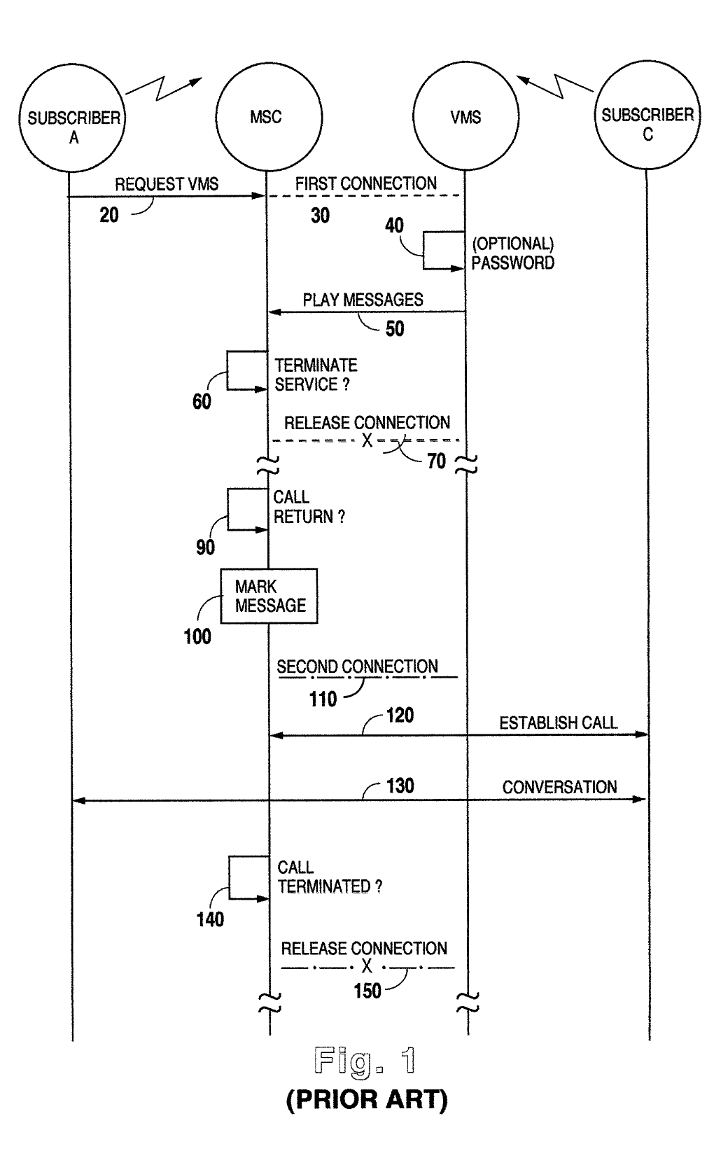

FIG. 2 is a signal flow diagram illustrating a first embodiment of the method of the present invention;

FIG. 3 is a signal flow diagram illustrating a second embodiment of the method of the present invention; and

FIG. 4 is a signal flow diagram illustrating a third embodiment of the method of the present invention.

### DETAILED DESCRIPTION OF PRESENTLY PREFERRED EXEMPLARY EMBODIMENTS

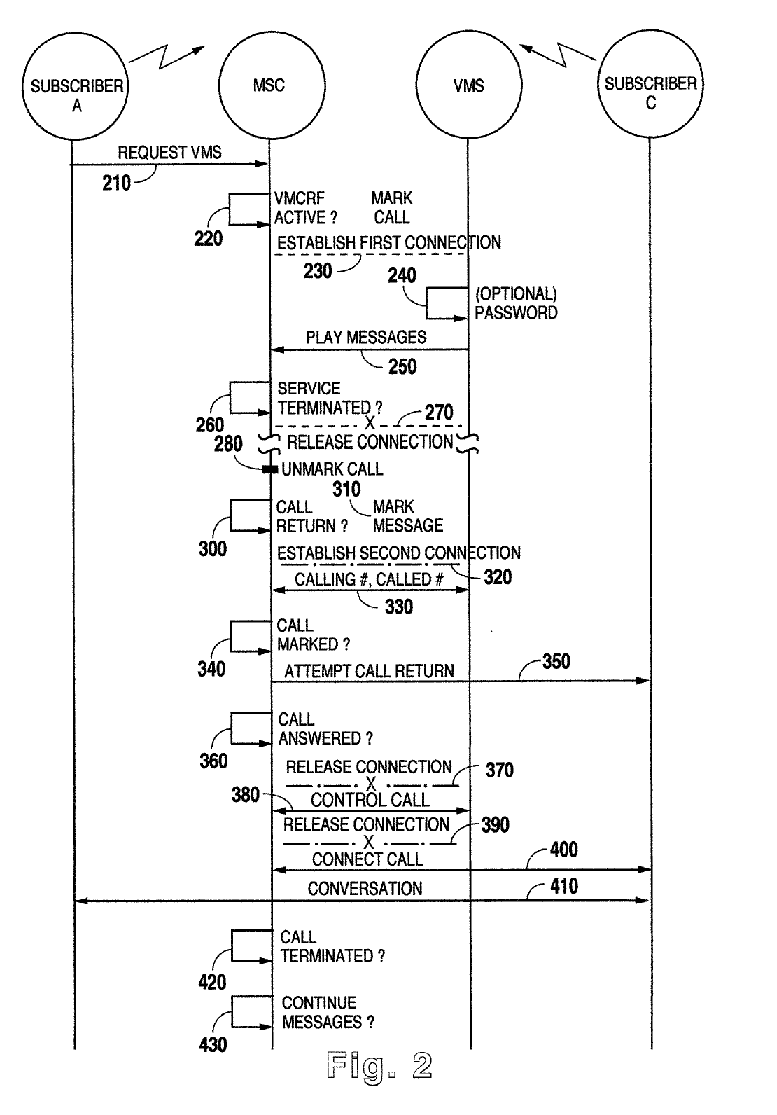

Turning now to FIG. 2, the method for processing voice mail message call returns can be seen. The method begins with step 210 by receiving a call request for the VMS from a calling number associated with the subscriber seeking to use the VMS voice mail service. Typically, the VMS is in electronic communication with a node which is currently serving the subscriber using a Signaling System #7 (SS7) network. The method continues in step 220, by verifying that a Voice Mail Call Return Feature (VMCRF), also known as the BOOMERING™ feature, is active. If so, then the call requesting the use of the VMS, and the associated voice mail service is marked as having the BOOMERING™ feature activated. This also occurs at step 220.

At this time, the first connection between the node and the VMS is established in step 230. After optionally obtaining the subscriber's password in step 240, the subscriber can listen to messages maintained and played by the voice mail service in step 250.

If the subscriber decides to terminate use of the voice mail service in step 260, by hanging up, or otherwise indicating that there is no longer any need to listen to messages, then the method continues with step 270 by releasing the first connection. The call requesting the VMS is unmarked, or marked as having the voice mail call return feature as inactive in step 280, and the method ends.

After accessing the voice mail services and listening to messages at step 250, if the subscriber hears a message having a call return number and indicates that call return activity is desired in step 300 (such that the VMS receives an indication to return the call), then the VMS will stop playing messages and mark the current message being played for return at a later time in step 310. Then a second connection between the VMS and the node is established in step 320, and the calling number (i.e., the subscriber number), and called number (i.e., the call return number) are sent to the node in step 330 from the VMS. If the call for the VMS has been marked as having the voice mail call return feature active, and this is detected in step 340, then there will be an attempt to call the call return number (i.e. the called number) in step 350. If the call to the call return number is not answered in step 360, then the second connection will be released in step 370, and the method will continue on to play messages at step 250. If it is determined that the call has not been marked with the voice mail call return feature as active in Step 340, the process will return to step 250, so that the subscriber can continue to listen to messages maintained by the voice mail service.

If the call to the call return number is answered in step 360, then the method continues with controlling the call using the node in step 380, releasing the second connection in step 390, and connecting the call (from the subscriber) to the call return number through the node in step 400. Conversation between the subscriber and the called party is established in step 410, and until it is terminated in step 420, continues at step 410. Once the call is terminated by the voice mail subscriber pressing a key to trigger switching back to the VMS services, or the node detects a call release by the called party, the subscriber may be queried as to whether the VMS should continue to play messages. The answer to the query can be established by pressing a predefined key on the subscriber telephone to reestablish dialog with the VMS and the voice mail service. If further access to messages is desired, then the method continues with playing messages at step 250. Otherwise, the method goes on to release the first connection at step 270 and the call is unmarked in step 280 and the method ends.

Presenting a query as to whether the subscriber desires to continue listening to messages in step 430 can be made by an announcement machine connected to, or operating within, the node. Pressing a key on the telephone to indicate the answer to the query results in receiving an in-band tone at the VMS using the first connection.

Thus, the essence of the method for processing a message having a call return number within the VMS that has a voice mail service, wherein the VMS is in electronic communication with a node, includes the steps of: receiving a call for the VMS from a calling number, verifying that a voice mail call return feature is active in conjunction with the calling number, establishing a first connection between the node and the VMS, accessing the VMS voice mail service, finding the message (having a call return number), establishing a second connection between the node and the VMS, controlling the call using the node, releasing the second connection, and establishing a third connection between the node and the call return number. The node may be a mobile switching center, such as a visited mobile switching center.

The step of finding the message may include the step of sequencing through a plurality of messages which include the message. The method may include the step of sending the call return number (i.e., the called number) and the calling number from the VMS to the node. The method may also include the steps of attempting to call the call return number, receiving an answer from the call return number to establish a conversation, sensing termination of the conversation, and reaccessing the voice mail service. The step of reaccessing the VMS voice mail service may include the step of receiving an in-band tone at the VMS using the first connection. The method may also include the step of marking the message as checked for later return to playing messages after the call return activity is completed.

The method of the invention illustrated in FIG. 2 has the dual advantage of releasing one of the connections between the node and the VMS during call return activity, and maintaining one of the connections between the VMS and the node for immediate return to voice accessing mail service activity by the subscriber. Thus, at least one connection is always maintained between the node and the VMS.

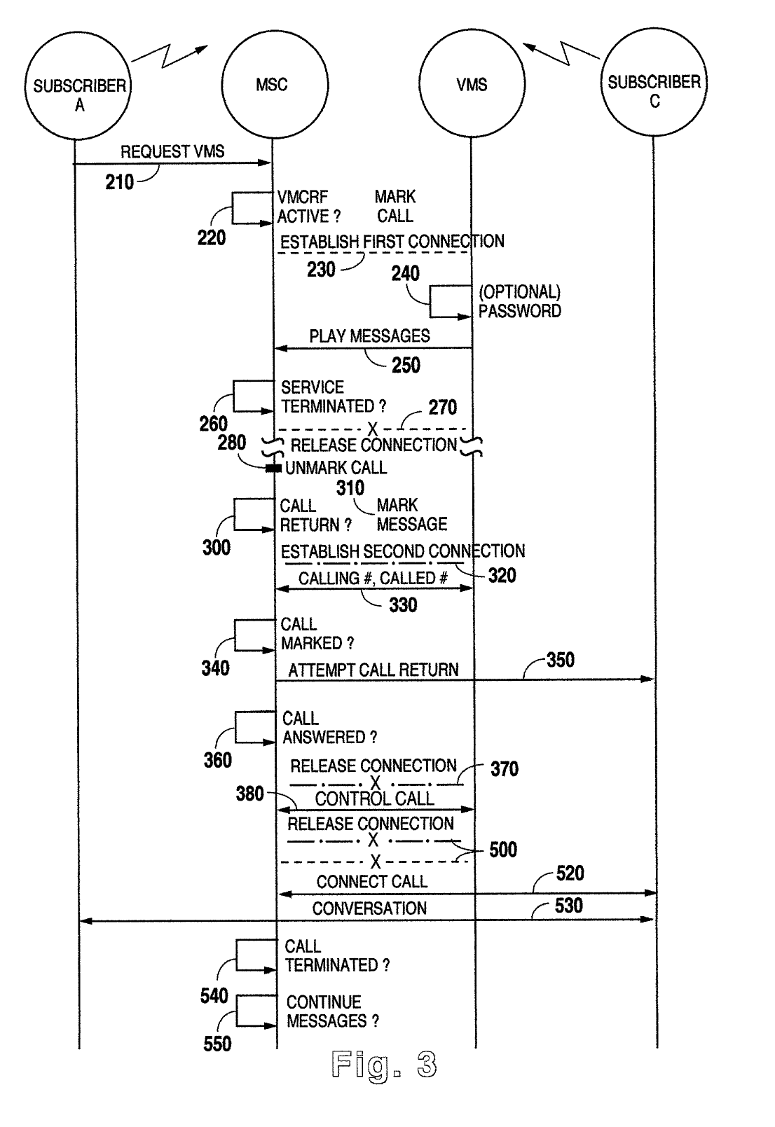

Turning now to FIG. 3, a second embodiment of the method of the present invention can be seen. In this case, if the party at the call return number answers the return call by the subscriber, both the first and the second connections are released between the node and the VMS. Thus, no connections are maintained between the node and the VMS during call return activity.

As can be seen by comparing the signal flow diagrams of FIG. 2 and FIG. 3, the first and second embodiments of the invention are substantially identical, until step 390 is reached in FIG. 2. At this point, in the embodiment shown in FIG. 3, the first and second connections between the node and the VMS are released in step 500. Then, the subscriber is connected to the call return number party in step 520, and a conversation is established in step 530. The conversation continues at step 530, until it is terminated in step 540. Termination of the conversation is sensed by the node detecting a call release from the called party (i.e., the call return number) or the subscriber pressing a key to send an in-band tone to the node to trigger reconnection to the VMS in step 550, and the method continues with (optional) step 240, and then step 250.

When a predefined key is pressed by the calling party (in-band tone) and received or identified in the node, the node will attempt to re-connect the calling party to the VMS to process the next message in step 550. The node can use the voice mail number received when the calling party was connected to the VMS the first time, or interrogate the HLR to get the number of the subscriber's VMS and then re-connect the subscriber to voice mail. These operations are transparent for the calling party, since there is no notice of re-connection to the VMS.

Thus, essentially, the second embodiment of the method of processing a message having a call return number within a VMS having a voice mail service in electronic communication with a node includes the steps of: receiving a call request for the VMS from a calling number, verifying that a voice mail call return feature is active in conjunction with the calling number, establishing a first connection between the node and the VMS, accessing the voice mail service, finding the message (having a call return number), establishing a second connection between the node and the VMS, controlling the call using the node, releasing the first and second connections, and establishing a third connection between the node and the call return number.

Again, the step of finding a message may include the step of sequencing through a plurality of messages including the message. The method may also include the step of sending the call return number and the calling number from the VMS to the node. Also included may be the steps of attempting to call the call return number, receiving an answer from the call return number to establish a conversation, sensing termination of the conversation, and reaccessing the voice mail service. In turn, the step of reaccessing the voice mail service may include the step of receiving an in-band tone at the node (which may be a mobile switching center, such as a visited mobile switching center). The method may also include the step of marking the message as checked, to indicate that it has already been played to the subscriber.

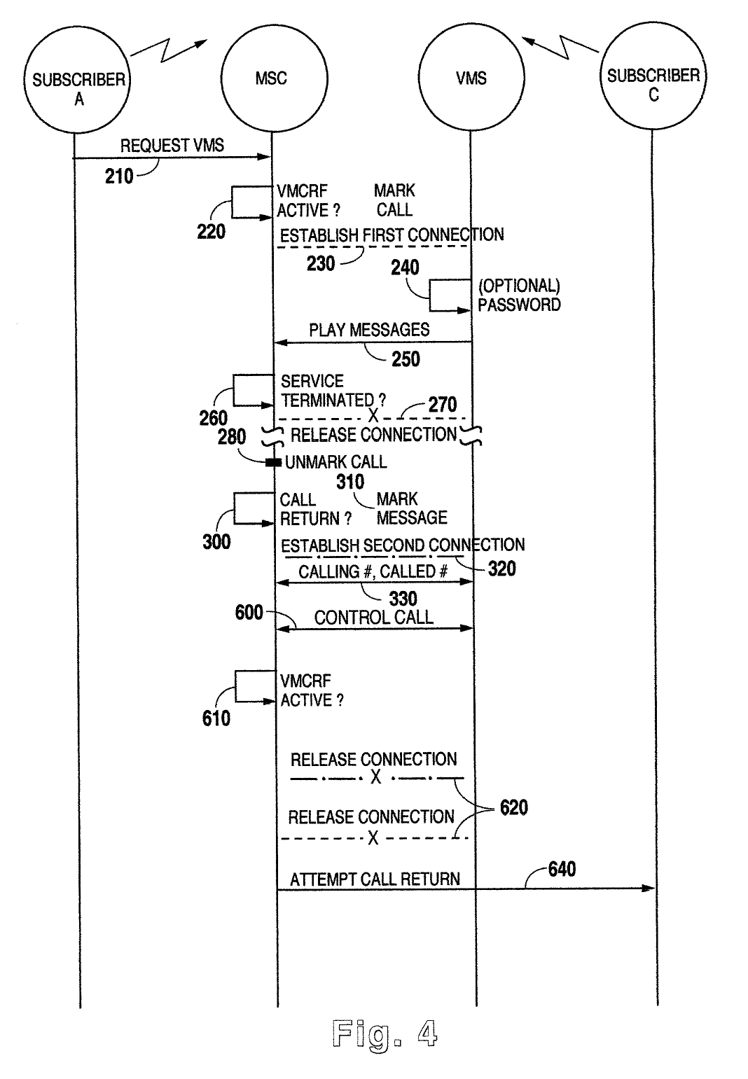

Turning now to FIG. 4, a third embodiment of the method of the present invention can be seen. In this case, the first and second connections between the node and the VMS are released prior to attempting to return the call to the call return number. By comparing FIGS. 2 and 4, it can be seen that the embodiments illustrated therein are substantially identical up until step 340 is reached in FIG. 2. In the third embodiment, the node is placed in control of the call in step 600, after sending the calling number and call return number to the node in step 330. In step 610, the method goes on to verify that the call request for the VMS has been marked as having the voice mail call return feature active. If it has not been marked, then the method goes on to allow the subscriber to continue listening to messages at step 250. If the call for the VMS has been marked as having the voice mail call return feature active, then the first and second connections between the node and the VMS are released in step 620. An attempt is made to place a call to the call return number at step 640. If no answer is received, then the method continues with step 230, wherein the subscriber is allowed to continue listening to messages, after re-connection to the VMS. However, if the call is answered, then the method continues at step 520 (see FIG. 3), and goes on to connect the call between the subscriber and the call return number through the node at step 520, since the connection has been released, and the message marked.

In essence, the third embodiment is a method of processing a message having a call return number within a Voice Message System (VMS) having a voice mail service in electronic communication with a node and comprises the steps of receiving a call for the VMS from a calling number, verifying that a voice mail call return feature is active in conjunction with the calling number, establishing a first connection between the node and the VMS, accessing the voice mail service, finding the message, establishing a second connection between the node and the VMS, controlling the call using the node, and releasing the first and second connections.

The advantage of the third embodiment is that the first and second connections between the node and the VMS are released as quickly as possible, freeing up the resources taken by call return activity at the node and the VMS. However, the ability to quickly free up these resources is traded off against not knowing whether the call to the call return number will be answered or not. In the second embodiment, the first and second connections are not released until the party at the call return number answers the return call placed by the subscriber.

It should be noted that call return activity can be repeated any number of times during the course of listening to messages. As shown in step 300, whenever a message is found with a call return number, and an indication is received that a call return is desired, the method can be implemented as shown in any one of the three illustrated embodiments.

Although the invention has been described with reference to specific embodiments, this description is not meant to be construed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

What is claimed is:

1. A method of processing a message having a call return number within a Voice Message System (VMS), including a voice mail service, in electronic communication with a node, comprising the steps of:
receiving a call for the VMS from a calling number;
verifying that a voice mail call return feature is active in conjunction with the calling number;
establishing a first connection between the node and the VMS;
accessing the voice mail service;
finding the message;
establishing a second connection between the node and the VMS;
controlling the call using the node;
releasing the second connection; and
establishing a third connection between the node and the call return number.

2. The method of claim 1, wherein the step of finding a message further includes the step of:
sequencing through a plurality of messages including the message.

3. The method of claim 1, wherein the node is a visited mobile switching center.

4. The method of claim 1, further including the step of:
sending the call return number and the calling number from the VMS to the node.

5. The method of claim 1, further including the steps of:
attempting to call the call return number;
receiving an answer from the call return number to establish a conversation;
sensing termination of the conversation; and
reaccessing the voice mail service.

6. The method of claim 5, wherein the step of reaccessing the voice mail services further includes the step of:
receiving an in-band tone at the VMS using the first connection.

7. The method of claim 1, further including the step of:
marking the message as checked.

8. A method of processing a message having a call return number within a Voice Message System (VMS), including a voice mail service, in electronic communication with a node, comprising the steps of:
receiving a call for the VMS from a calling number;
verifying that a voice mail call return feature is active in conjunction with the calling number;
establishing a first connection between the node and the VMS;
accessing the voice mail service;
finding the message;
establishing a second connection between the node and the VMS;
controlling the call using the node;
releasing the first and second connections; and
establishing a third connection between the node and the call return number.

9. The method of claim 8, wherein the step of finding a message further includes the step of:
sequencing through a plurality of messages including the message.

10. The method of claim 8, wherein the node is a visited mobile switching center.

11. The method of claim 8, further including the step of:
sending the call return number and the calling number from the VMS to the node.

12. The method of claim 8, further including the steps of:
attempting to call the call return number;
receiving an answer from the call return number to establish a conversation;
sensing termination of the conversation; and
reaccessing the voice mail service.

13. The method of claim 12, wherein the step of reaccessing the voice mail services further includes the step of:
receiving an in-band tone at the node.

14. The method of claim 8, further including the step of:
marking the message as checked.

15. A method of processing a message having a call return number within a Voice Message System (VMS), including a voice mail service, in electronic communication with a node, comprising the steps of:
receiving a call for the VMS from a calling number;
verifying that a voice mail call return feature is active in conjunction with the calling number;
establishing a first connection between the node and the VMS;
accessing the voice mail service;
finding the message;
establishing a second connection between the node and the VMS;
controlling the call using the node; and
releasing the first and second connections.

16. The method of claim 15, wherein the step of finding a message further includes the step of:
sequencing through a plurality of messages including the message.

17. The method of claim 15, wherein the node is a visited mobile switching center.

18. The method of claim 15, further including the step of:
sending the call return number and the calling number from the VMS to the node.

19. The method of claim 15, further including the steps of:
attempting to call the call return number;
receiving an answer from the call return number to establish a conversation; and
establishing a third connection between the node and the call return number.

20. The method of claim 19, further including the steps of:
terminating the conversation; and
reaccessing the voice mail service.

21. The method of claim 20, wherein the step of reaccessing the voice mail services further includes the step of:
receiving an in-band tone at the node.

22. The method of claim 15, further including the step of:
marking the message as checked.
